(19) United States
(12) Patent Application Publication
(10) Pub. No.: US 2010/0100447 A1
(43) Pub. Date: Apr. 22, 2010

(54) TOY SYSTEM AND EXTRAVAGANZA PLANNER

(75) Inventor: Howard Ganz, North York (CA)

Correspondence Address: Pearne & Gordon LLP, 1801 East 9th Street, Suite 1200, Cleveland, OH, 44114-3108, US

(73) Assignee: GANZ, Woodbridge (CA)

(21) Appl. No.: 12/255,113

(22) Filed: Oct. 21, 2008

(51) Int. Cl. G06Q 30/00; G06F 21/00; G06F 3/14

(52) U.S. Cl. 705/14.66; 726/21; 715/234

(57) ABSTRACT

A customer may obtain an authorization which allows accessing a website that has prestored templates which are each associated with use by the customer. The authorization may be obtained by purchasing products. The prestored templates each represent an event that can be hosted at a place of business. The templates each include activities that can be hosted, days when the activities can be hosted, and times for the activities. The customer can select activities by the customer, and automatically produce pages and form an Internet webpage which advertises the activities based on said templates and information about the customer.

### BACKGROUND

Selling toys often includes various marketing efforts for the toys. Different kinds of toys can be marketed in different ways.

### SUMMARY

The present application describes a system and method that allows those who have purchased a specified assortment of toys (presumably toy reseller) to produce automatically information about real-world events that can be illustrated on a website. According to an embodiment, templates on the toy company's website are used to create web pages that have the logos, look and feel of the marketing material that is individual for the toy seller, using the formats and forms made by the manufacturer. The marketing material can advertise special events as an advertisement for the toys.

### BRIEF DESCRIPTION OF THE DRAWINGS

These and other aspects will now be described in detail with reference to the accompanying drawings, wherein:

FIG. 1 shows an introduction to the event planner;

FIG. 2 illustrates a main page of the event planner;

FIG. 3 and 4 show different drop-down menus;

FIG. 5 shows different event planner marketing materials;

FIG. 6 illustrates a schedule events; and

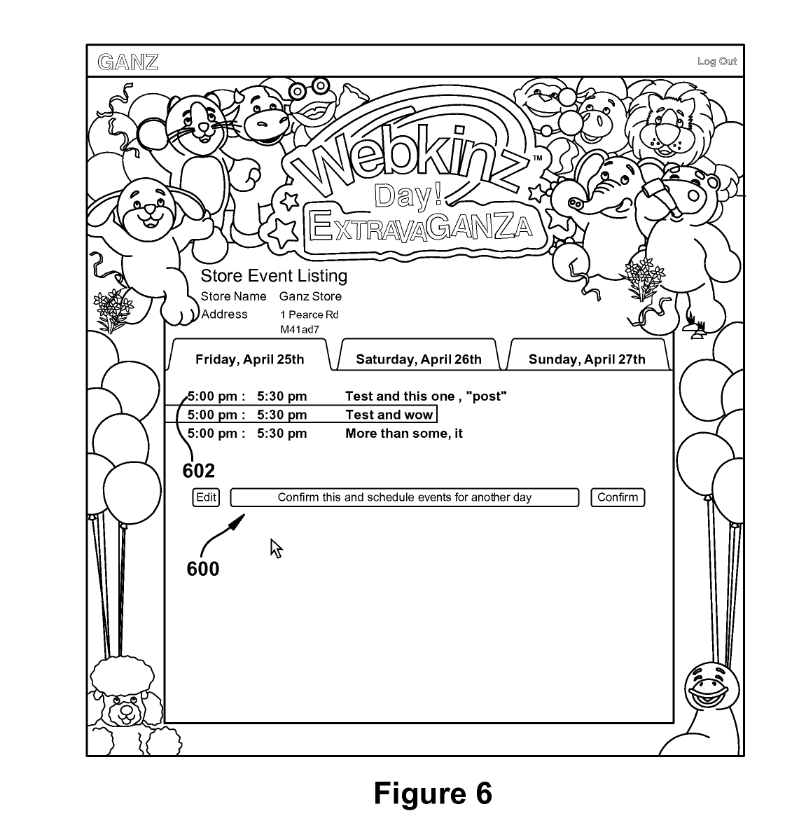

FIG. 7 illustrates a schedule events for a different day.

### DETAILED DESCRIPTION

Our co-pending application Ser. No. 11/027647, filed Dec. 30, 2004, and incorporated in its entirety herein by reference, discusses a system of interacting with a virtual representation of a real world product. According to this system, a user can buy a toy which is associated with a special code. The toy exists in the real world, and the code forms a key to the virtual world. The user enters the code on a website and enters the virtual world.

The virtual world provides activities and views with which the user can interact. The virtual world, as part of the interaction, provides a virtual replica of the actual toy. Users can carry out various activities on the website using their virtual version of the toy. For example, the user can form a house with rooms, furniture, things, clothing, and other things. The user can also carry out activities to earn virtual cash, and purchase virtual items using that virtual cash.

According to an embodiment, users who order a specific product or group of products receive access to the manufacturer's website template system that allows creation of webpages or specific content. In an embodiment, the customer may be required to purchase an assortment of specified numbers of product, e.g., toys. Another embodiment might allow access for any purchase. In an embodiment, the computer determines eligibility from a customer number. Another embodiment might provide the user with a special code that provides the access. This portion provides the ability to use templates on the toy seller's website in order to provide access to these templates to the toy seller. The templates bring up web pages which can be hosted on a website, e.g. the toy seller's website or on the manufacturer's website. In an embodiment, the manufacturer's website can be linked to the toy seller's website.

The templates use the look and feel of the manufacturer's marketing material—e.g. fonts, logos and colors from manufacturer's marketing material, in order to allow the reseller access to the marketing material and to presentation of the marketing material, in a way that facilitates selling the assortment that has been purchased.

In an embodiment, a user or a reseller purchases a specified assortment of toys. Upon purchasing that specified item or items, the reseller obtains an authorization to use the extravaganza event along with those toys.

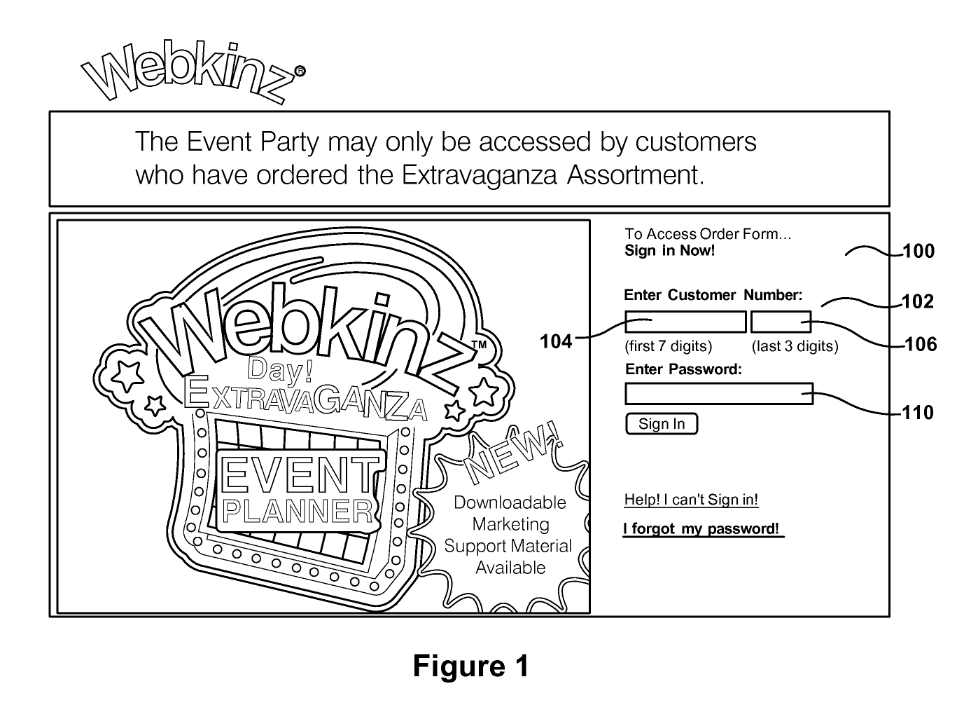

In the embodiment, the user enters a specified web address, and is provided with the webpage 100 in FIG. 1. Webpage 100 is for example hosted on the toy manufacturer's website. The page is accessed by a user entering their customer number, which can be a two-part customer number with a first seven digit portion 104 and a three digit portion 106. The computer can determine whether the user has made the requisite purchase. In another embodiment, the portion 106 can be a special three digit code given by the toy manufacturer to the purchaser when the purchaser purchases an assortment. That three digit code, for example, might only be usable for a limited time during which the promotion is ongoing. The user may also be given a password which is entered at 110, or alternatively, the password may be the standard account password.

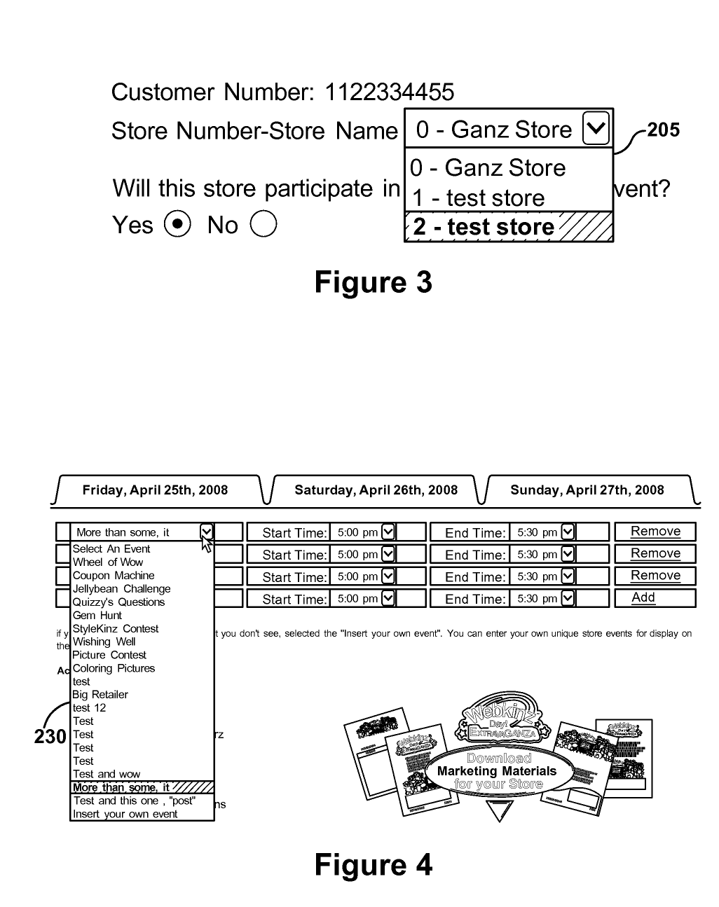

Upon entering a valid username and password, the main event planner page 200 may be obtained. This may provide the users customer number 202, along with a number of different possibilities for the user. Many toy retailers have a number of stores. Accordingly, the reseller can select any of their stores at 205 using the pull-down menu. FIG. 3 illustrates the pull-down menu, and illustrates how all of the user stores can be selected from this menu. Each store on the pull-down menu can be separately selected in this embodiment. The user can then select a store, and indicate whether that store will participate or not participate at 210.

A participating store can use a number of different events. 215 shows each of a plurality of different possible events which can be selected. For example, each of the events can also be clicked on to see the characteristics of the event. When the user selects an event, for example, the coupon machine 216, user obtains a file that shows information about the coupon machine event.

In an embodiment, many of these events are real-world versions of events and/or games that can be played on the website. For example, the coupon machine 216 is an in-person event that allows the user, in person at the retailer's store, to play the coupon machine game. This may be the same game playable on the toy manufacturer's website. The game may be playable on a local computer, or as a real version of a similar game; having the same rules and rewards as the game on the website. Each of these games may allow the users to obtain virtual cash or rewards or other prizes. The prizes may be real world prizes and/or may be prizes usable on the manufacturer's website on which the game is usually played.

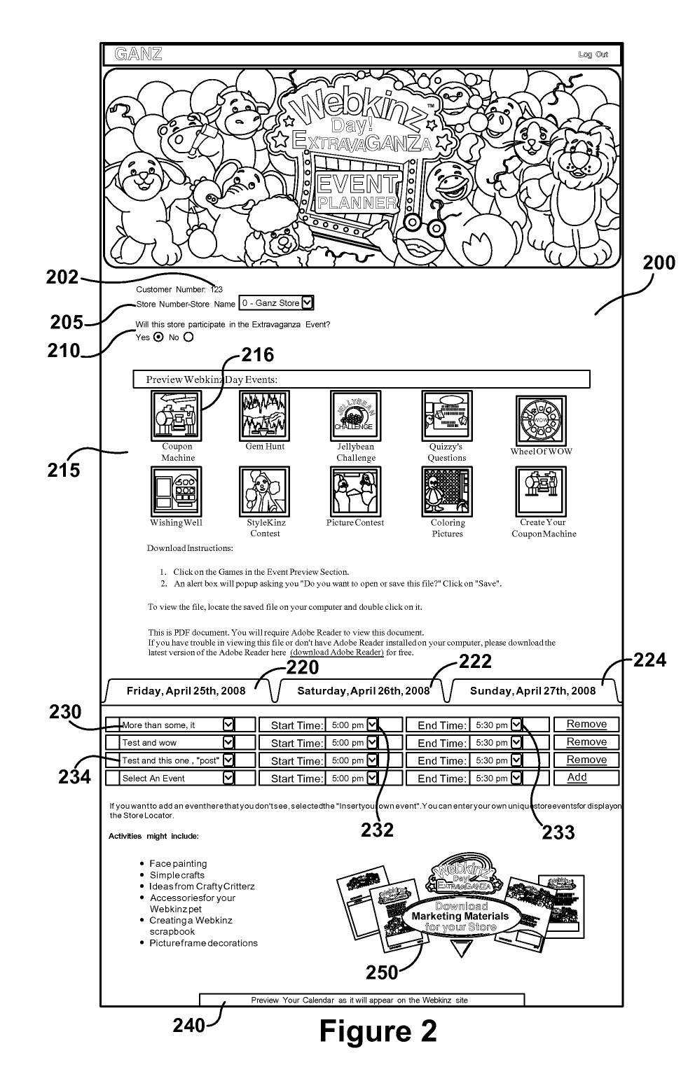

The embodiment allows a number of different games to be separately scheduled. For example, FIG. 2 shows an embodiment in which there are tabs 220, 222, 224 which each represent a separate day.

FIG. 2 illustrates the events and the different possibilities for the days, event day 220, here a Friday. A number of different possibilities are possible. For each possibility, a drop-down menu 230 allows choosing one of the events. FIG. 4 shows the drop-down menu 230, and the different events that can be selected. Note that events like the “coupon machine” shown as 216 can be selected from the select and event possibilities. Certain “own events” may also be possible. For example, you can select your own events such as face painting, accessories, scrapbooking, or the like. Any of these events become user-planned, as compared with the events in the drop-down menu which are events based entirely on the prestored template. For each event such as 230, the user can also select the start time 232, and the end time 233. Any number of events can have the same or different start times. Each of these events can be executed on a computer in the store, or can be based on materials that are sent to the store.

When the user has completed, the button 240 may be selected to preview the calendar as it will appear on the website.

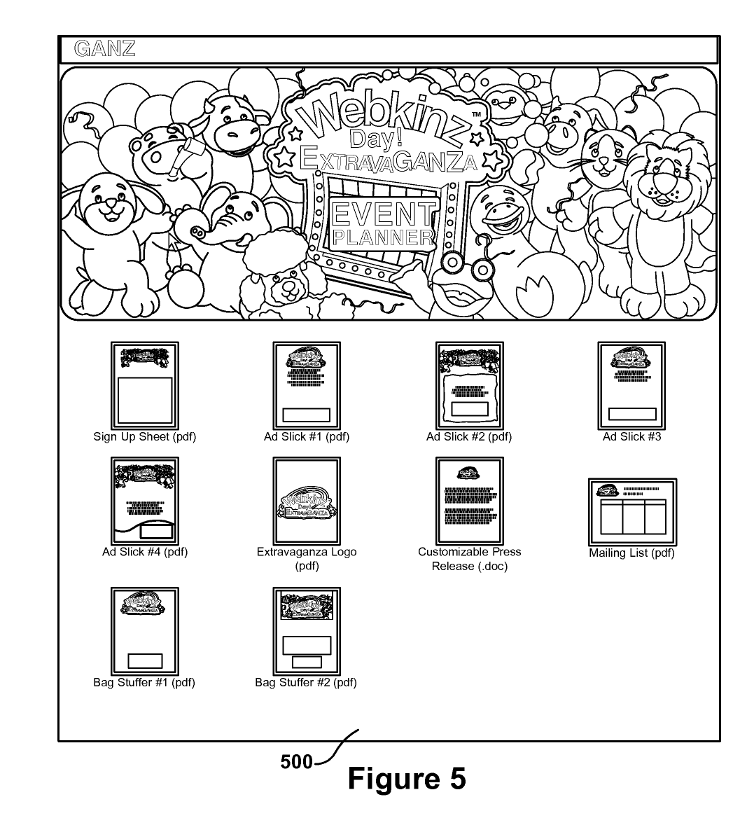

The user can also download marketing materials for the store to further promote the event. FIG. 5 illustrates the marketing materials 500, which can include signup sheet, ads, logos, press release, mailing lists, etc.

Upon executing the button 240, a preview of the website is shown as 600. Note that the shows the website based activities for April 25.

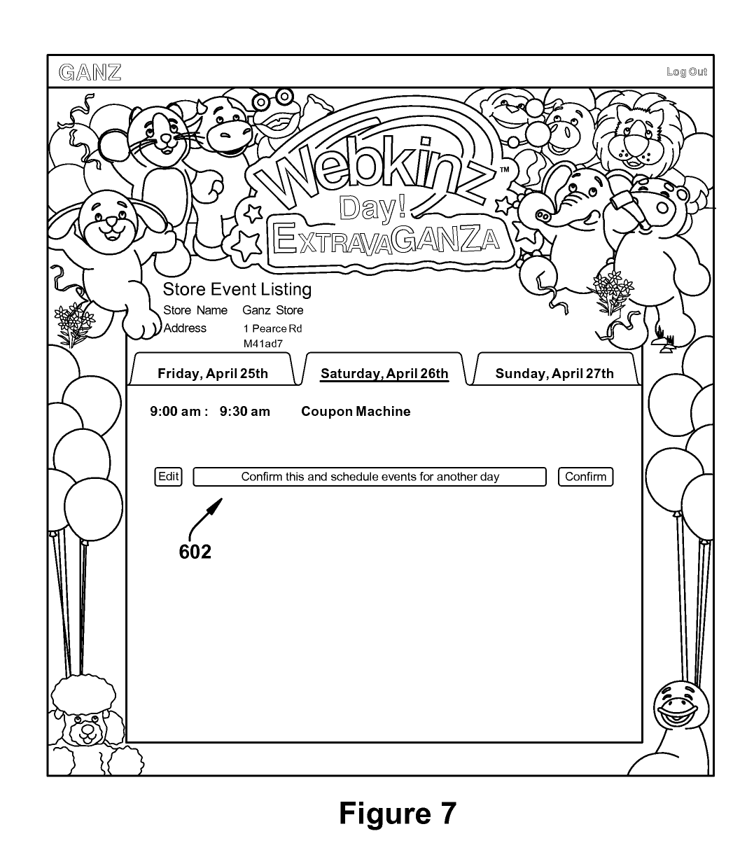

FIG. 7 shows the website based activities 602 for the following day, April 26.

The templates form internet webpages that have information associated with the manufacturer, e.g., logos, fonts, color, and other look and feel associated with the manufacturer. However, those pages are customized for the reseller, the location of the reseller and the specific events selected by the reseller.

Once these events are confirmed, they are published; which may involve publishing this to the manufacturer's own website (which in an embodiment may be linked to the reseller's website), and/or publishing into a special portion of the reseller's website. Note that the items selected as 230 in FIG. 2 shows as scheduled events on the website. For example, the item 234 shows on the website as item 602.

The above embodiment describes forming information indicative of events using “templates”, where the templates may include limits on forms and words. An advantage of templates is that it constrains the events, the words that are used, and the format. This provides automatic control over the items on the website, and prevents the items formed on the website from being outside the parameters desired by the website owner. For example, it prevents certain kinds of words from being used including but not limited to obscenities. It constrains the style. However, more generally, the disclosed system can be used to plan an event without a template, in a totally free-form manner, for example using widgets with fill-in boxes and the ability to resize and/or re-locate the widgets. Examples might include allowing users to post “free hot dogs”, “free plans”, “give away balloons”.

While the above requires users to make a specific purchase in order to get access to this website system, other embodiments may provide access to the system to anyone, or anyone with a user id, or simply based on registration.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, while the above describes certain kinds of events, it should be understood that other widgets can similarly be used. Moreover, this can be used on other styles and kinds of websites.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers which are used to host the website and/or to access the website may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cellphone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A method comprising:
selling at least one product to a customer;
providing an authorization to the customer who has purchased the at least one product which allows accessing a website that has prestored templates, where each of said prestored templates are associated with re-selling the product from the customer;
storing information about the customer;
accepting input from the customer that allows selection from said prestored templates each represent an event that can be hosted at a place of business, said templates each include all of activities that can be hosted, days when the activities can be hosted, and times for the activities; and
after receiving selection of activities by the customer, automatically producing pages which form an Internet webpage which advertises the activities based on said templates, said input from said customer and said information about the customer.

2. A method as in claim 1, wherein said activities are shown as pulldown menus.

3. A method as in claim 1, further comprising allowing the customer to select one of a plurality of different stores associated with the customer, and to schedule said events for any of said plurality of different stores.

4. A method as in claim 2, further comprising allowing the user to download marketing material associated with each of a plurality of different activities associated with said pulldown menus.

5. A method as in claim 1, wherein said hosting comprises hosting said Internet webpages on a website associated with the manufacturer.

6. A method as in claim 1, wherein said hosting comprises hosting said Internet webpage which uses logos associated with the manufacturer.

7. A method as in claim 1, wherein said activities comprise analogous activities which can be carried out on a website of the manufacturer.

8. A method as in claim 1, wherein said activities that are carried out at the customer's location earn reward points that can be redeemed on a website of the manufacturer.

9. A method as in claim 1, wherein said hosting comprises hosting an Internet webpage on a website associated with the customer.

10. A method comprising:
on a website, accessing templates for internet web pages that have marketing information associated with a manufacturer;
customizing those templates for a customer to include at least a location of the customer and at least one specific event being hosted at a customer's location; and
forming a web page based on said templates to include both said marketing information associated with said manufacturer and said specific information of said customer.

11. A method as in claim 10, wherein said marketing information includes at least one logo associated with the manufacturer.

12. A method as in claim 10, wherein said marketing information includes at least a font, a color and at least one logo associated with the manufacturer.

13. A method as in claim 10, wherein said templates include information about activities that can be hosted, days when the activities can be hosted, and times for the activities.

14. A method as in claim 13, wherein said activities are selected from pulldown menus.

15. A method as in claim 10, further comprising allowing the customer to select one of a plurality of different stores associated with the customer as part of said customizing, and to schedule said events for any of said plurality of different stores.

16. A method as in claim 10, further comprising hosting said webpage on a server.

17. A method as in claim 16, wherein said hosting comprises hosting Internet webpages on a website associated with the manufacturer.

18. A method as in claim 13, wherein said activities comprise activities with a same title as activities which can be carried out on the manufacturer's website.

19. A method as in claim 10, further comprising selling at least one product to a customer;
providing an authorization to the customer who has purchased the at least one product which allows accessing the templates; and
preventing access to the templates to users who do not have said authorization.

20. A method comprising:
providing an authorization to a customer which allows accessing a system that allows forming internet web pages;
using said system for describing a specific event and to form a web page indicating said specific event; and
publishing said web page including information about said specific event.

21. A method as in claim 20 further comprising using templates to form said webpage.

22. A method as in claim 20 wherein said system provides web pages that display marketing information associated with a manufacturer.

23. A method as in claim 20 wherein said providing comprises selling at least one product to said customer and providing said authorization to said customer.

24. A method as in claim 23, wherein said marketing information includes at least one logo associated with a manufacturer.

25. A method as in claim 24, wherein said marketing information includes at least a font, a color and at least one logo associated with the manufacturer.

26. An apparatus comprising:
a computer programmed to receive an authorization to allow access to a website that has prestored templates based on receipt of an authorization, where each of said prestored templates are associated with a product and said templates usable to create a web page representing an event that can be hosted, said templates each include all of activities that can be hosted, days when the activities can be hosted, and times for the activities, and said computer storing information about a customer who is accessing said website based on said authorization, and retrieving said information based on said authorization, and automatically producing pages which form an Internet webpage which advertises the activities based on said templates, input from said customer, and said information about the customer.

27. An apparatus as in claim 26, wherein said activities are shown as pulldown menus.

28. An apparatus as in claim 26, wherein said templates allow the customer to select one of a plurality of different stores associated with the customer, and to schedule said events for any of said plurality of different stores as said input.

29. An apparatus as in claim 26, wherein said templates allow the user to download marketing material associated with each of a plurality of different activities associated with said pulldown menus.

30. An apparatus as in claim 26, wherein said computer also hosts said Internet webpages on a website.

31. An apparatus as in claim 26, wherein said templates use logos associated with a manufacturer.

32. An apparatus as in claim 26, wherein said activities comprise analogous activities which can be carried out on a manufacturer's website.

33. An apparatus as in claim 26, wherein said activities that are carried out at the customer's location earn reward points that can be redeemed on a manufacturer's website.

34. An apparatus as in claim 26, wherein said hosting comprises hosting an Internet webpage on a website associated with the manufacturer.

35. A method comprising:
receiving at a computer an authorization from a customer who has purchased at least one product;
accessing a website that has prestored templates, where each of said prestored templates are associated with re-selling the product from the customer,
said computer and said prestored templates being used to create a web page representing an event that can be hosted at a place of business, said templates each include all of activities that can be hosted, days when the activities can be hosted, and times for the activities;
accessing information about the customer based on said authorization; and
automatically producing pages which form an Internet webpage which advertises the activities based on said templates and information about the customer.

36. A method as in claim 35, wherein said activities are shown as pulldown menus.

37. A method as in claim 35, further comprising allowing the customer to select one of a plurality of different stores associated with the customer, and to schedule said events for any of said plurality of different stores.

38. A method as in claim 36, further comprising allowing the user to download marketing material associated with each of a plurality of different activities associated with said pulldown menus.

39. A method as in claim 35, wherein said hosting comprises hosting said Internet web pages on a website associated with the customer.

40. A method as in claim 35, wherein said hosting comprises hosting said Internet webpage which uses logos associated with the customer.

41. A method as in claim 35, wherein said activities comprise analogous activities to activities which can be carried out on the customer's website.

42. A method as in claim 35, wherein said activities that are carried out at the customer's location earn reward points that can be redeemed on the customer's website.

43. A method as in claim 35, wherein said hosting comprises hosting an Internet webpage on a website associated with the customer.
